(19) United States
(12) Patent Application Publication
(10) Pub. No.: US 2010/0301674 A1
(43) Pub. Date: Dec. 2, 2010

(54) CONTROL CIRCUIT AND ELECTRONIC DEVICE INCLUDING THE SAME

(76) Inventor: Chih-Hsiung Lin, TAIPEI CITY (TW)

Correspondence Address: NORTH AMERICA INTELLECTUAL PROPERTY CORPORATION, P.O. BOX 506, MERRIFIELD, VA, 22116, US

(21) Appl. No.: 12/790,965

(22) Filed: May 31, 2010

(30) Foreign Application Priority Data
Jun. 1, 2009 (TW) 098118025

(51) Int. Cl. H02J 9/00

(52) U.S. Cl. 307/66

(57) ABSTRACT

This invention provides a control circuit and an electronic device including the same. The control circuit is disposed in an electronic device for connecting a power supply. The electronic device includes a battery module. The control circuit includes a detecting unit, a processing unit, a control unit, and a switch. When the power supply is connected to the electronic device, the detecting unit provides a detecting result. The processing unit determines a type of the power supply according to the detecting result. When the processing unit determines that the power supply is a solar power adapter, the processing unit outputs a first control signal and a turn-off signal. The control unit controls operation of the battery module according to the first control signal. Further, the switch is turned off according to the turn-off signal, preventing the power supply from supplying power to the electronic device.

### CROSS-REFERENCE TO RELATED APPLICATIONS

This Non-provisional application claims priority under 35 U.S.C. §119(a) on Patent Application No(s). 098118025 filed in Taiwan, Republic of China on Jun. 1, 2009, the entire contents of which are hereby incorporated by reference.

### BACKGROUND OF THE INVENTION

1. Field of the Invention

This invention relates to a control circuit and, more particularly, to a control circuit and an electronic device including the same.

2. Description of the Related Art

With development of technology and increase of users' needs, a plurality of electronic devices are designed to be thinner and thinner thus to facilitate carrying by the users. Most of portable electronic devices, such as a notebook computer, a tablet computer, a mobile phone, a personal digital assistant, a multimedia player, or a digital camera, can selectively obtain power from batteries or commercial power.

When the portable electronic device obtains the power from the commercial power, an AC-DC adapter is usually needed to adjust voltage and current of the commercial power to be within an acceptable range of the portable electronic device. Further, the AC-DC adapter can also provide stable voltage and current for the portable electronic device thus to maintain stability of each component in the portable electronic device.

In addition, a universal serial bus (USB) widely used at present can transmit about 5V power. Therefore, some portable electronic devices with lower power consumption, such as a mobile phone, a multimedia player and so on, can be connected to the commercial power or data processing systems, such as a computer, via USB cables thus to obtain the power from the commercial power or the data processing systems.

Further, with improvement of environmental consciousness, skilled persons in the related art strive to use natural energy, such as solar energy, to generate power. Using the solar energy to generate power can prevent energy from being exhausted in a long time and being monopolized.

However, at present, efficiency of converting the solar energy to power energy is still low, and in one day, intensity of the solar energy changes with positions of the sun and weather at any time, which limits an application range of products using the solar energy.

### BRIEF SUMMARY OF THE INVENTION

One objective of this invention is to provide a control circuit. Particularly, the control circuit in the invention can determine different power sources and can adjust power configuration modes according to the different power sources.

A control circuit in the invention is provided in an electronic device and is connected a power supply. The electronic device includes a battery module. The control circuit includes a detecting unit, a processing unit, a control unit, and a switch.

When the power supply is connected to the electronic device, the detecting unit provides a detecting result. The processing unit is connected to the detecting unit for determining a type of the power supply according to the detecting result. The control unit is connected to the processing unit and the battery module. The switch is connected to the power supply and the processing unit.

When the processing unit determines that the power supply is a solar power adapter, the processing unit outputs a first control signal and a turn-off signal. The control unit controls operation of the battery module according to the first control signal, and the switch is turned off according to the turn-off signal, preventing the power supply from supplying power to the electronic device.

Another objective of the invention is to provide an electronic device connected to a power supply and/or a battery module.

An electronic device in the invention includes a connecting unit and a control circuit. The connecting unit is used for connecting the power supply. The control circuit includes a detecting unit, a processing unit, a control unit, and a switch. The detecting unit is connected to the connecting unit.

When the connecting unit is connected to the power supply, the detecting unit provides a detecting result. The processing unit is connected to the detecting unit for determining a type of the power supply according to the detecting result. The control unit is connected to the processing unit and the battery module. The switch is connected to the power supply and the processing unit.

When the processing unit determines that the power supply is a solar power adapter, the processing unit outputs a first control signal and a turn-off signal. The control unit controls operation of the battery module according to the first control signal, and the switch is turned off according to the turn-off signal, preventing the power supply from supplying power to the electronic device.

To sum up, the control circuit in the invention can determine the type of the power supply according to the detecting result and can control the battery module and the power supply in the electronic device to perform corresponding operation.

These and other features, aspects, and advantages of the present invention will become better understood with regard to the following description, appended claims, and accompanying drawings.

### BRIEF DESCRIPTION OF THE DRAWINGS

FIG. 1 is a functional block diagram showing a control circuit according to one embodiment of the invention.

FIG. 2 is a functional block diagram showing a control circuit according to one embodiment of the invention.

FIG. 3 is a functional block diagram showing an electronic device according to one embodiment of the invention.

FIG. 4 is a functional block diagram showing a control circuit according to one embodiment of the invention.

FIG. 5 is a functional block diagram showing an electronic device according to one embodiment of the invention.

FIG. 6 is a partial three-dimensional view showing an electronic device and a solar power adapter according to one embodiment of the invention.

### DETAILED DESCRIPTION OF THE INVENTION

One preferred embodiment of the invention provides a control circuit, capable of determining different power sources and adjusting power configuration modes according to the different power sources, and an electronic device including the same. A plurality of preferred embodiments about the control circuit and the electronic device in the invention are described hereinbelow.

According to one preferred embodiment of the invention, the electronic device may refer to any device needing power for operation and, more particularly, to a data processing device such as a computer. The data processing device particularly refers to a portable data processing device such as a notebook computer, a tablet computer, an image capturing device, a multimedia player, a mobile communication device, a personal digital assistant and so on. However, the invention is not limited thereto.

A solar power adapter and an AC-DC adapter as power supplies are taken for example hereinbelow thus to describe an application mode of the control circuit and the electronic device according to one preferred embodiment of the invention.

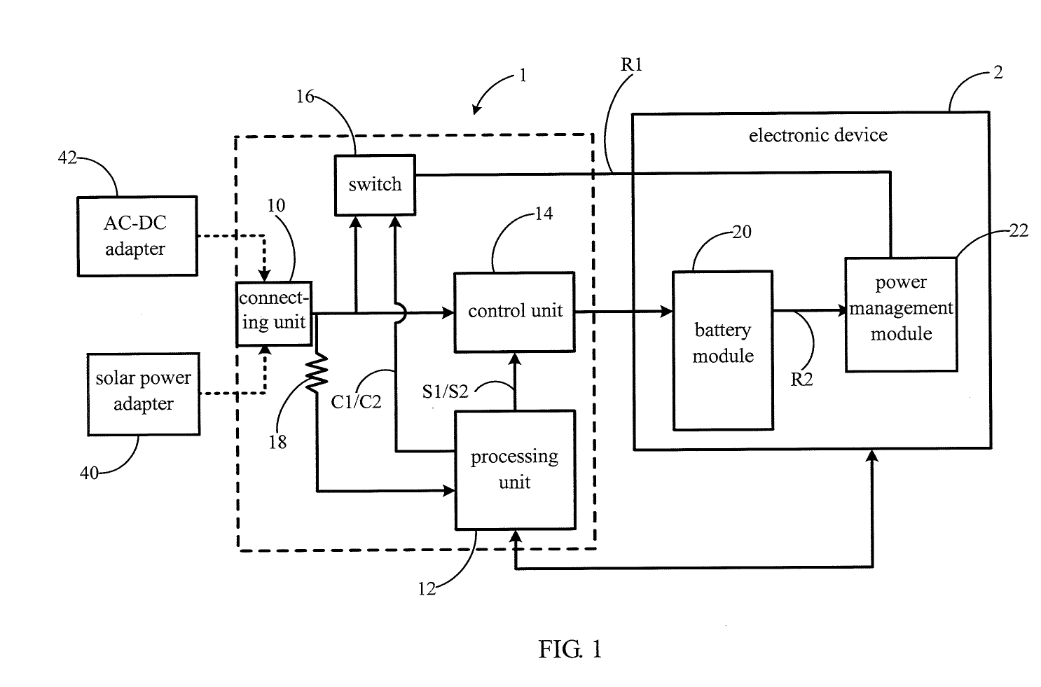

FIG. 1 is a functional block diagram showing a control circuit 1 according to one embodiment of the invention. In FIG. 1, the control circuit 1 includes a connecting unit 10, a processing unit 12, a control unit 14, a switch 16, and a detecting unit 18.

The connecting unit 10 can be selectively coupled with a solar power adapter 40 or an AC-DC adapter 42. The processing unit 12 is coupled with the connecting unit 10, the control unit 14, the switch 16, and an electronic device 2, respectively. The control unit 14 is coupled with the connecting unit 10 and a battery module 20 of the electronic device 2, respectively. The switch 16 is coupled with the connecting unit 10 and a power management module 22 of the electronic device 2, respectively. The detecting unit 18 is coupled between the connecting unit 10 and the processing unit 12. In the embodiment, the detecting unit 18 is a voltage-dividing resistor. Further, a first power path R1 is formed between the switch 16 and the power management module 22, and a second power path R2 is formed between the battery module 20 and the power management module 22.

The connecting unit 10 can be connected to the solar power adapter 40 or the AC-DC adapter 42 thus to receive power supplied by the solar power adapter 40 or the AC-DC adapter 42 and can transmit the power to the processing unit 12 after the detecting unit 18 divides a voltage of the power. The processing unit 12 detects a voltage of the power after the detecting unit 18 divides the voltage of the power and determines whether the connecting unit 10 is currently connected to the solar power adapter 40 or the AC-DC adapter 42 according to the voltage. In other words, in the embodiment, when the detecting unit 18 is connected to the solar power adapter 40 or the AC-DC adapter 42, the detecting unit 18 can provide a detecting result (such as a divided voltage), and the processing unit 12 can determine a type of the power supply currently connected to the detecting unit 18 or the connecting unit 10 according to the detecting result.

In an actual application, the voltage of the power supplied by the solar power adapter 40 is usually less than that supplied by the AC-DC adapter 42. Therefore, a plurality of threshold values may be built in the processing unit 12, and the processing unit 12 may compare the detected voltage with the threshold values thus to determine the type of the power supply connected to the connecting unit 10.

When the processing unit 12 determines that the solar power adapter 40 is connected to the connecting unit 10, the processing unit 12 outputs a first control signal S1 and a turn-off signal C1.

The control unit 14 receives the first control signal S1 and controls charge and discharge of the battery module 20 according to the first control signal S1. The battery module 20 may include a first battery and a second battery. According to the first control signal S1, the control unit 14 controls the first battery and the second battery to alternately supply power to the electronic device 2 and controls the first battery and the second battery to be alternately charged by the solar power adapter 40. For example, the control unit 14 controls the first battery to be charged by the solar power adapter 40 and controls the second battery to supply the power to the power management module 22 via the second power path R2. Then, the power management module 22 distributes the power to each component or module in the electronic device 2.

The switch 16 receives the turn-off signal C1 and is turned off according to the turn-off signal C1, preventing the power supplied by the solar power adapter 40 from passing through the switch 16. In other words, when the processing unit 12 determines that the power supply connected to the connecting unit 10 is the solar power adapter 40, the control circuit 1 in the preferred embodiment of the invention allows the first power path R1 to be opened, such that the solar power adapter 40 fails to directly supply the power to the electronic device 2 and only charges the batteries in the battery module 22.

When the processing unit 12 determines that the AC-DC adapter 42 is connected to the connecting unit 10 according to the voltage of the power, the processing unit 12 outputs a second control signal S2 and a turn-on signal C2.

The control unit 14 receives the second control signal S2 and controls the charge and discharge of the battery module 20 according to the second control signal S2. As described above, the battery module 20 includes a first battery and a second battery. According to the second control signal S2, the control unit 14 controls the first battery and the second battery to be simultaneously charged by the AC-DC adapter 42.

The switch 16 receives the turn-on signal C2 and is turned on according to the turn-on signal C2, allowing the power supplied by the AC-DC adapter 42 to pass through the switch 16 and to be supplied to the power management module 22 via the first power path R1. In other words, when the processing unit 12 determines that the power supply connected to the connecting unit 10 is the AC-DC adapter 42, the control circuit 1 in the preferred embodiment of the invention allows the first power path R1 to be closed and the second power path R2 to be opened, such that the AC-DC adapter 42 directly supplies the power to the electronic device 2 and simultaneously charges the batteries in the battery module 22.

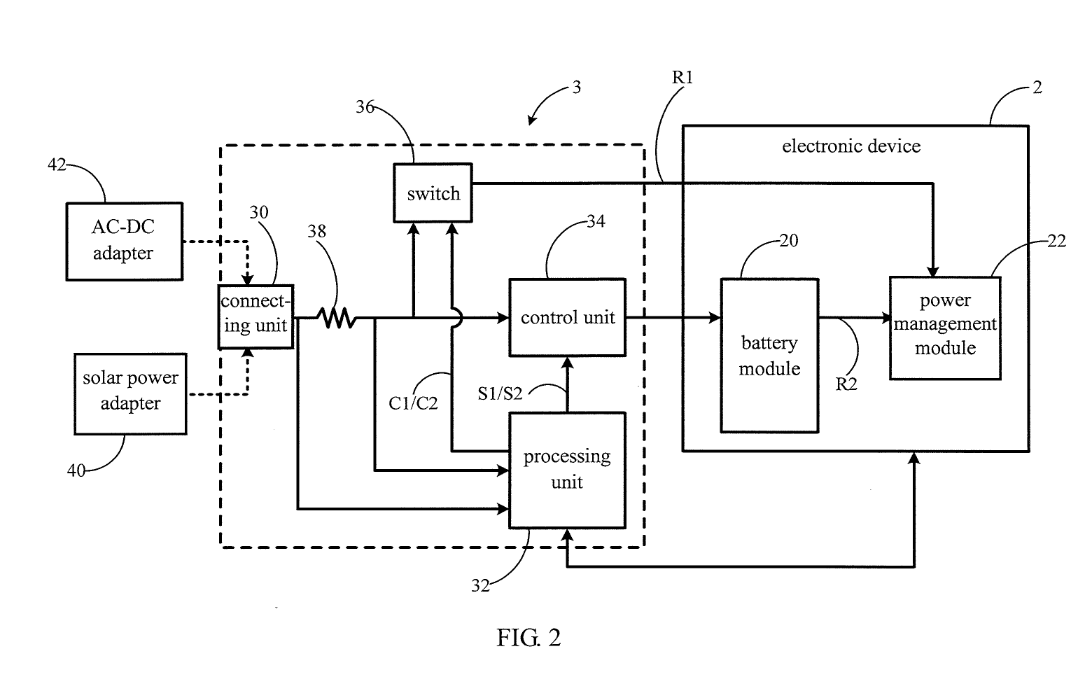

FIG. 2 is a functional block diagram showing a control circuit 3 according to another embodiment of the invention. In FIG. 2, the control circuit 3 includes a connecting unit 30, a processing unit 32, a control unit 34, a switch 36, and a detecting unit 38.

The difference between the control circuit 1 in FIG. 1 and the control circuit 3 is that the detecting unit 38 of the control circuit 3 in FIG. 2 is an induced current resistor and the processing unit 32 is coupled with two terminals of the detecting unit 38, respectively, thus to obtain a voltage difference between the two terminals of the detecting unit 38. Then, the processing unit 32 calculates a current of power flowing through the detecting unit 38 according to the voltage difference and a resistance of the detecting unit 38, and the processing unit 32 determines whether a power supply connected to the connecting unit 30 is a solar power adapter 40 or an AC-DC adapter 42 according to the current.

In the embodiment, the two terminals of the induced current resistor have the voltage difference, such that the detecting result is the voltage difference. According to the voltage difference, the processing unit 32 performs corresponding operation to determine a type of the power supply.

The current of the power supplied by the solar power adapter 40 is usually less than that supplied by the AC-DC adapter 42. Therefore, a plurality of threshold values may be built in the processing unit 32, and the processing unit 12 can compare the detected current with the threshold values thus to determine the type of the power supply connected to the connecting unit 30.

When the processing unit 32 determines that the solar power adapter 40 is connected to the connecting unit 30, the processing unit 32 outputs a first control signal S1 and a turn-off signal C1. On the other hand, when the processing unit 32 determines that the AC-DC adapter 42 is connected to the connecting unit 30, the processing unit 32 outputs a second control signal S2 and a turn-on signal C2. In the embodiment, operation performed by the control unit 34 according to the control signals S1, S2 and operation performed by the switch 36 according to the turn-off signal C1 or the turn-on signal C2 is the same as that described above. Therefore, it is not described herein for a concise purpose.

The processing unit in the embodiment determines that the connecting unit is not connected to any power supply according to a voltage or a current of the circuit between the processing unit and the connecting unit. At that moment, the processing unit generates a third control signal, and the control unit drives the first battery and the second battery in the battery module to alternately supply power to the electronic device according to the third control signal.

The control circuit in the embodiment determines the type of the power supply according to other electrical characteristics of the power. Otherwise, the control circuit determines the type of the power supply according to more than one electrical characteristic (for example, according to the aforementioned voltage and current simultaneously) of the power. However, the invention is not limited thereto. Further, the control circuit in the embodiment adopts other proper power configuration mechanisms according to different power supplies. However, the invention is not limited thereto.

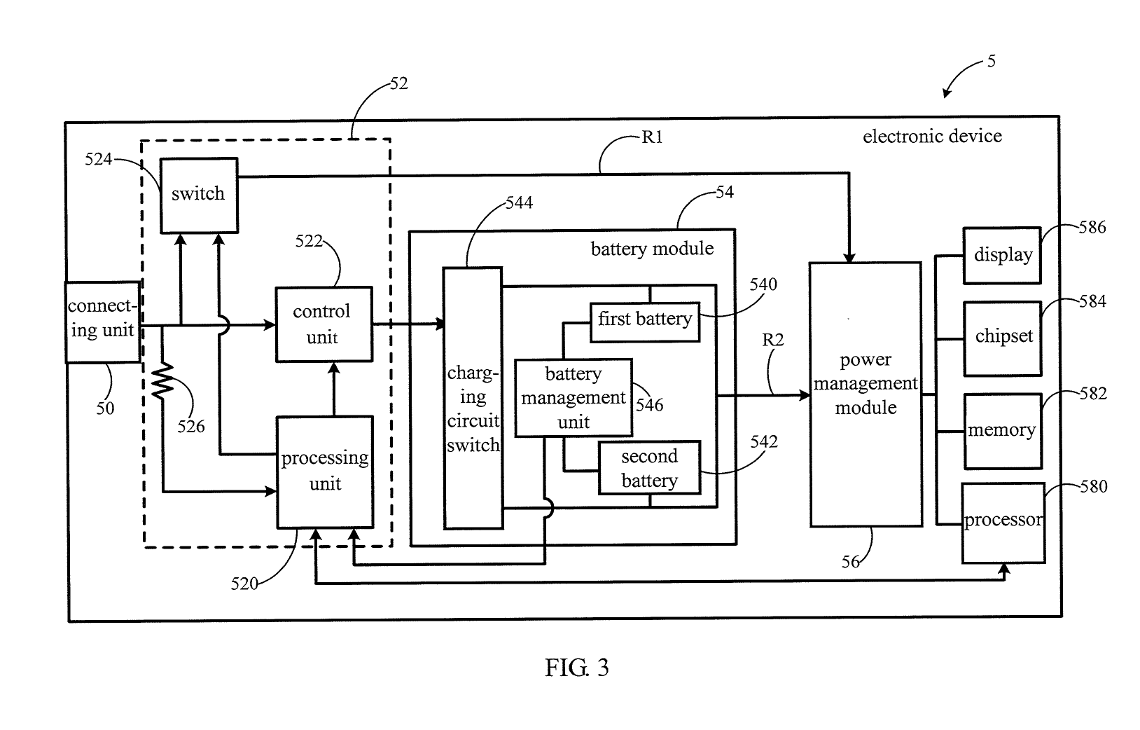

The invention further provides an electronic device including the aforementioned control circuit. FIG. 3 is a functional block diagram showing an electronic device 5 according to one embodiment of the invention. In FIG. 3, the electronic device 5 in the embodiment includes a connecting unit 50, a control circuit 52, a battery module 54, a power management module 56, and a plurality of electronic components including units or modules, such as a processor 580, a memory 582, a chipset 584, a display 586 and so on, needed by operation of the electronic device 5.

The connecting unit 50, such as a plugging hole, can allow different kinds of power supplies as mentioned above to be connected by a user. The control circuit 52 includes a processing unit 520, a control unit 522, a switch 524, and a detecting unit 526. The battery module 54 includes a first battery 540, a second battery 542, a charging path switch 544, and a battery management unit 546.

In the embodiment, connections, operation, and functions of the processing unit 520, the control unit 522, the switch 524, and the detecting unit 526 of the control circuit 52 are the same as that described above. Therefore, they are not described herein for a concise purpose.

The charging path switch 544 of the battery module 54 is connected to the control unit 522, the first battery 540, and the second battery 542, respectively. The charging path switch 544 is controlled by the control unit 522 thus to switch connection states between a power supply (a solar power supply 40 or an AC-DC adapter 42) and the first battery 540 and the second battery 542.

For example, when the control unit 522 receives a first control signal S1 outputted by the processing unit 520, the control unit 522 drives the charging path switch 544 to allow the path between the control unit 522 and the first battery 540 to be closed and the path between the control unit 522 and the second battery 542 to be opened. Thus, the solar power adapter 40 can charge the first battery 540 instead of the second battery 542 via the control unit 522 and the charging path switch 544.

Further for example, when the control unit 522 receives a second control signal S2 outputted by the processing unit 520, the control unit 522 drives the charging path switch 544 to simultaneously allow the path between the control unit 522 and the first battery 540 and the path between the control unit 522 and the second battery 542 to be closed. Thus, the AC-DC adapter 42 can simultaneously charge the first battery 540 and the second battery 542 via the control unit 522 and the charging path switch 544. Certainly, in an actual application, operation of the charging path switch 544 may be adjusted according to other mechanisms. However, the invention is not limited thereto.

In addition, the battery management unit 546 is connected to the processing unit 520, the first battery 540, and the second battery 542. The battery management unit 546 regularly detects states of the first battery 540 and the second battery 542 to obtain a state value such as remaining capacity, a temperature, a discharge voltage, a discharge current and so on. However, the invention is not limited thereto. Further, the battery management unit 546 feeds back the state value to the processing unit 520.

The power management module 56 can be connected to the first battery 540, the second battery 542, and the switch 524 in a plugging mode or a soldering mode thus to receive power supplied by the first battery 540, the second battery 542, or the power supply. In addition, the power management module 56 is further connected to the units or modules, such as the processor 580, the memory 582, the chipset 584, the display 586 and so on, respectively, thus to distribute the power needed by operation to the units or modules.

The control circuit 52 in the embodiment may be integrated into a single circuit board and may be disposed in a proper device or module such as the aforementioned electronic device 5 or the battery module 54; according to different conditions, the control circuit 52 may also be separately disposed in different devices or modules. For example, the control unit 522, the charging path switch 544, and the battery management unit 546 may be disposed in the battery module 54, and the processing unit 520 and the switch 524 may be disposed in the electronic device 5.

The processing unit 520, the control unit 522, and the switch 524 may be components having proper functions according to different conditions. For example, the processing unit 520 may be a micro processor or an embedded controller; the switch 524 may be a field effect transistor (FET). However, the invention is not limited thereto.

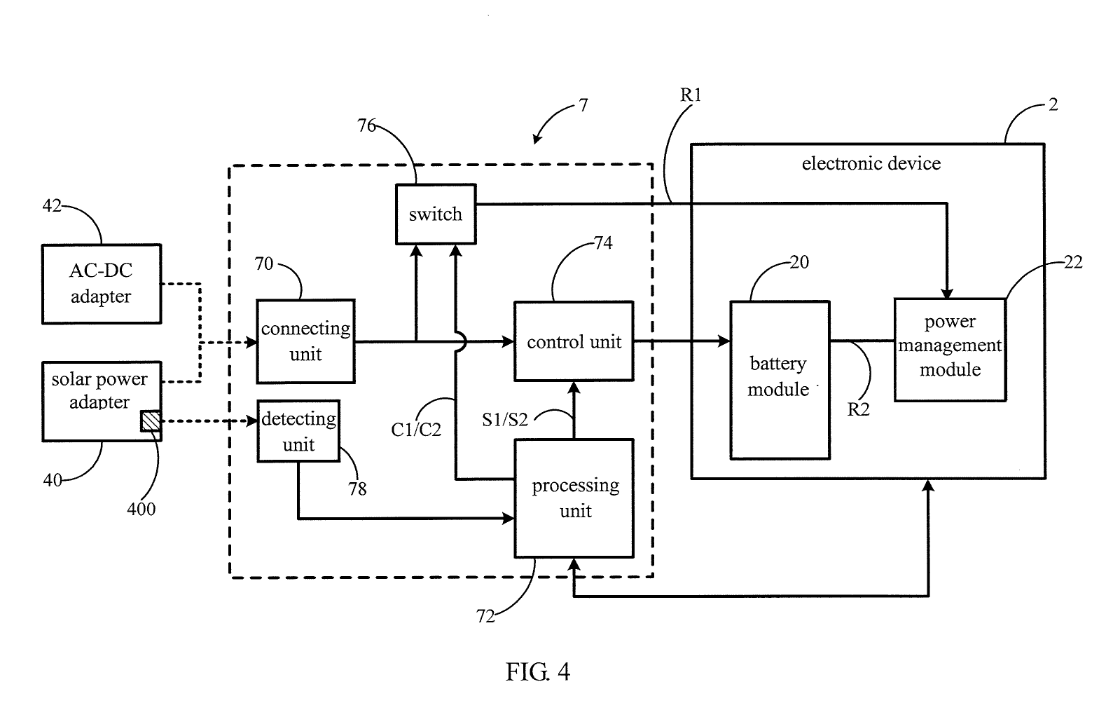

FIG. 4 is a functional block diagram showing a control circuit 7 according to one embodiment of the invention. In FIG. 4, the control circuit 7 in the embodiment includes a connecting unit 70, a processing unit 72, a control unit 74, a switch 76, and a detecting unit 78. The processing unit 72 is coupled with the control unit 74, the switch 76, the detecting unit 78, and an electronic device 2, respectively. The control unit 74 is coupled with the connecting unit 70 and a battery module 20 in the electronic device 2, respectively. The switch 76 is coupled with the connecting unit 70 and a power management module 22 in the electronic device 2, respectively. The battery module 20 is coupled with the power management module 22. Further, a first power path R1 is formed between the switch 76 and the power management module 22, and a second power path R2 is formed between the battery module 20 and the power management module 22.

The connecting unit 70 is selectively coupled with a solar power adapter 40 or an AC-DC adapter 42. When the connecting unit 70 is connected to the solar power adapter 40, the connecting unit 70 can receive power from the solar power adapter 40, and the detecting unit 78 can be connected to an identification unit 400 (such as a metal conductor) of the solar power adapter 40 to be in a first connecting state. In the embodiment, the detecting unit 78 is a detecting node. That is, in the embodiment, a detecting result of the detecting unit 78 is a connection state (including the first connecting state and a second connecting state) of the detecting node. The processing unit 72 can determine a type of the power supply according to the detecting result.

According to the first connecting state, the processing unit 72 outputs a first control signal S1 and a turn-off signal C1. The control unit 74 receives the first control signal S1 and controls charge and discharge of the battery module 20 according to the first control signal S1. As described above, the control unit 74 can simultaneously control the battery module 20 to be charged by the solar power adapter 40 and can control the battery module 20 to supply power to the power management module 22 via the second power path R2. Further, the switch 76 receives the turn-off signal C1 and is turned off according to the turn-off signal C1, such that the power supplied by the solar power adapter 40 cannot pass through the switch 76 and cannot be supplied to the power management module 22 via the first power path R1.

In addition, when the connecting unit 70 is connected to the AC-DC adapter 42, the connecting unit 70 can receive power from the AC-DC adapter 42, and the detecting unit 78 is not connected to any component to be in the second connecting state.

At that moment, according to the second connecting state, the processing unit 72 outputs a second control signal S2 and a turn-on signal C2. The control unit 74 receives the second control signal S2 and controls the charge and discharge of the battery module 20 according to the second control signal S2. As described above, the control unit 74 controls the battery module 20 to be charged by the AC-DC adapter 42 and can allow the second power path R2 to be opened, such that the battery module 20 cannot supply the power to the power management module 22. Further, the switch 76 receives the turn-on signal C2 and is turned on according to the turn-on signal C2, such that the power supplied by the AC-DC adapter 42 can pass through the switch 76 and can be supplied to the power management module 22 via the first power path R1.

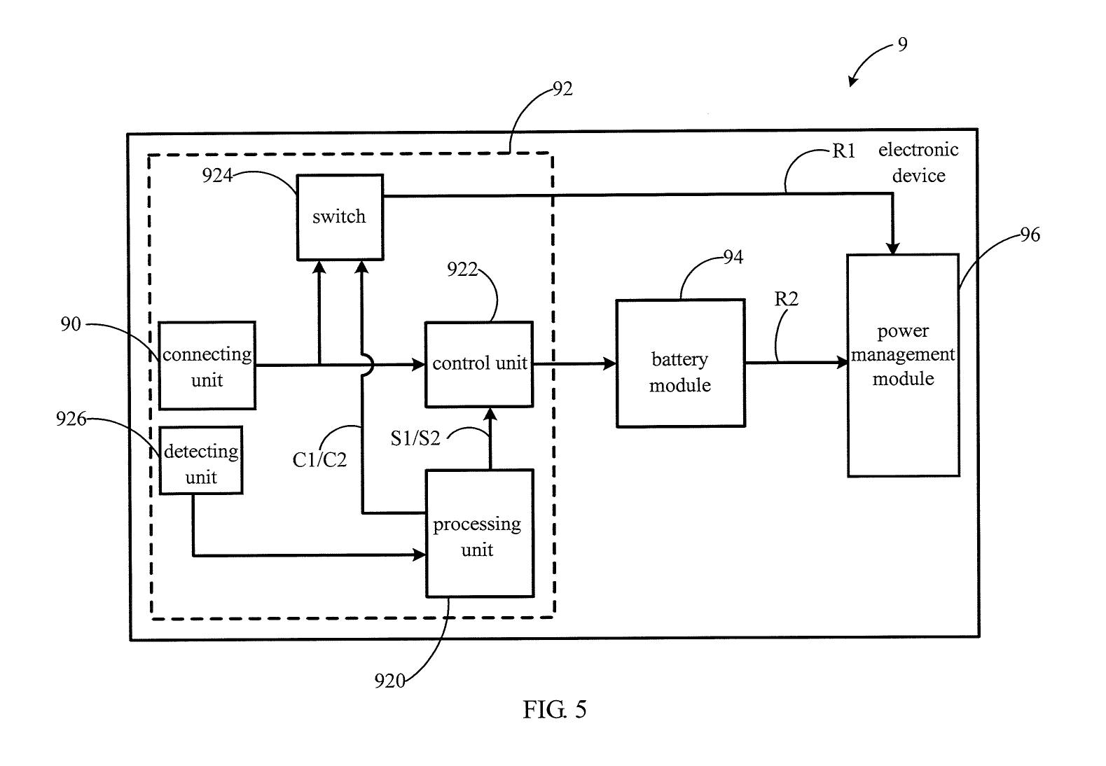

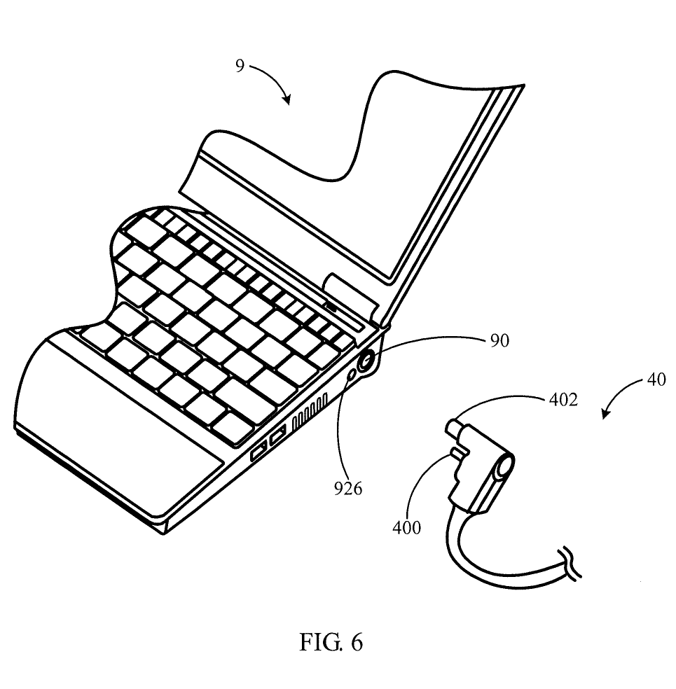

Please refer to FIG. 5 and FIG. 6 together. FIG. 5 is a functional block diagram showing an electronic device 9 according to one embodiment of the invention. FIG. 6 is a partial three-dimensional view showing the electronic device 9 and a solar power adapter 40 according to one embodiment of the invention.

In the embodiment, the electronic device 9 includes a connecting unit 90, a control circuit 92, a battery module 94, and a power management module 96 as mentioned above. The electronic device 9 may further include a central processing unit, an interface card, a memory, a hard disk, a display, or other components or modules needed by operation.

The control circuit 92 includes a processing unit 920, a control unit 922, a switch 924, and a detecting unit 926. In FIG. 6, the connecting unit 90 and the detecting unit 926 can be plugging holes. When the connecting unit 90 is connected to the solar power adapter 40, the connecting unit 90 is connected to a power supply terminal 402 of the solar power adapter 40 thus to receive power from the solar power adapter 40, and the detecting unit 926 is connected to an identification unit 400 (such as a conductor) of the solar power adapter 40 to be in a first connecting state.

The processing unit 920 is coupled with the control unit 922, the switch 924, and the detecting unit 926 for outputting a first control signal S1 and a turn-off signal C1 according to the first connecting state. The control unit 922 is coupled with the connecting unit 90 and the battery module 94. The control unit 922 receives the first control signal S1. According to the first control signal S1, the control unit 922 controls the battery module 94 to be charged by the solar power adapter 40 and controls the battery module 94 to supply power to the power management module 96 via a second power path R2. Then, the power management module 96 distributes the power to each unit or module in the electronic device 9. The switch 924 is coupled with the connecting unit 90 and the power management module 96, respectively, for receiving the turn-off signal C1 and is turned off according to the turn-off signal C1, such that the power supplied by the solar power adapter 40 cannot pass through the switch 924. Therefore, the solar power adapter 40 fails to supply the power to the power management module 96 via a first power path R1.

The connecting unit 90 of the electronic device 9 in the embodiment can also be connected to an AC-DC adapter. At that moment, the connecting unit 90 is connected to a power supply terminal of the AC-DC adapter thus to receive power from the AC-DC adapter. The AC-DC adapter does not have the aforementioned conductor or other identification units. Therefore, the detecting unit 926 is not connected to any component thus to be in a second connecting state. At that moment, according to the second connecting state, the processing unit 920 of the control circuit 92 in the embodiment outputs a second control signal S2 and a turn-on signal C2. According to the second control signal S2, the control unit 922 controls the battery module 94 to be charged by the AC-DC adapter and controls the battery module 94 to avoid supplying power to the power management module 96. Further, the switch 924 receives the turn-on signal C2 and is turned on according to the turn-on signal C2, such that the AC-DC adapter supplies the power to the power management module 96 via the switch 924. Then, the power management module 96 distributes the power to each unit or module in the electronic device 9.

To sum up, according to the embodiments of the invention, the control circuit can determine the type of the power supply according to electrical characteristics of the power and can control the battery module in the electronic device and the power supply to perform corresponding operation according to the determination result. In addition, when the power source is the solar power adapter, the control circuit in the embodiments can control one battery unit of the battery module to be charged by the solar power adapter and can control another battery unit of the battery module to supply the power to the electronic device. Further, the control circuit in the embodiments can switch between charge and discharge according to the state of each battery unit thus to prolong using time of the electronic device by efficiently using power energy converted from solar energy.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A control circuit provided in an electronic device and connected to a power supply, the electronic device including a battery module, the control circuit comprising:
a detecting unit for providing a detecting result when the power supply is connected to the electronic device;
a processing unit connected to the detecting unit for determining a type of the power supply according to the detecting result;
a control unit connected to the processing unit and the battery module; and
a switch connected to the power supply and the processing unit,
wherein when the processing unit determines that the power supply is a solar power adapter, the processing unit outputs a first control signal and a turn-off signal, the control unit controls operation of the battery module according to the first control signal, and the switch is turned off according to the turn-off signal, preventing the power supply from supplying power to the electronic device.

2. The control circuit according to claim 1, wherein the detecting unit includes a voltage-dividing resistor, the detecting result is a divided voltage after the voltage-dividing resistor divides a voltage of the power, and the processing unit determines the type of the power supply according to the divided voltage.

3. The control circuit according to claim 1, wherein the detecting unit includes an induced current resistor, the detecting result is a voltage difference between two terminals of the induced current resistor, and the processing unit allows the voltage difference to be divided by a resistance of the induced current resistor to obtain a current thus to determine the type of the power supply.

4. The control circuit according to claim 1, wherein the detecting unit includes a detecting node connected to an identification unit of the solar power adapter, the detecting result is a first connecting state of the detecting node and the identification unit, and the processing unit determines the type of the power supply according to the first connecting state.

5. The control circuit according to claim 1, wherein the processing unit is an embedded controller.

6. The control circuit according to claim 1, wherein the battery module comprises a first battery and a second battery, and according to first control signal, the control unit controls the first battery and the second battery to alternately supply the power to the electronic device and controls the first battery and the second battery to be alternately charged by the solar power adapter.

7. The control circuit according to claim 1, wherein when the processing unit determines that the power supply is an AC-DC adapter, the processing unit outputs a second control signal and a turn-on signal, the control unit controls the power supply to charge the battery module according to the second control signal, and the switch is turned on according to the turn-on signal, allowing the power supply to supply the power to the electronic device via the switch.

8. The control circuit according to claim 7, wherein the battery module includes a first battery and a second battery, and the control unit controls the AC-DC adapter to charge the first battery and the second battery according to the second control signal.

9. An electronic device connected to a power supply and a battery module, the electronic device comprising:
a connecting unit for connecting the power supply; and
a control circuit including:
a detecting unit connected to the connecting unit, when the connecting unit is connected to the power supply, the detecting unit providing a detecting result;
a processing unit connected to the detecting unit for determining a type of the power supply according to the detecting result;
a control unit connected to the processing unit and the battery module; and
a switch connected to the power supply and the processing unit,
wherein when the processing unit determines that the power supply is a solar power adapter, the processing unit outputs a first control signal and a turn-off signal, the control unit controls operation of the battery module according to the first control signal, and the switch is turned off according to the turn-off signal, preventing the power supply from supplying power to the electronic device.

10. The electronic device according to claim 9, wherein the detecting unit includes a voltage-dividing resistor, the detecting result is a divided voltage after the voltage-dividing resistor divides a voltage of the power, and the processing unit determines the type of the power supply according to the divided voltage.

11. The electronic device according to claim 9, wherein the detecting unit includes an induced current resistor, the detecting result is a voltage difference between two terminals of the induced current resistor, and the processing unit allows the voltage difference to be divided by a resistance of the induced current resistor to obtain a current thus to determine the type of the power supply.

12. The electronic device according to claim 9, wherein the detecting unit includes a detecting node connected to an identification unit of the solar power adapter, the detecting result is a first connecting state of the detecting node and the identification unit, and the processing unit determines the type of the power supply according to the first connecting state.

13. The electronic device according to claim 9, wherein the processing unit is an embedded controller.

14. The electronic device according to claim 9, wherein the battery module includes a first battery and a second battery, and according to first control signal, the control unit controls the first battery and the second battery to alternately supply the power to the electronic device and controls the first battery and the second battery to be alternately charged by the solar power adapter.

15. The electronic device according to claim 9, wherein when the processing unit determines that the power supply is an AC-DC adapter, the processing unit outputs a second control signal and a turn-on signal, the control unit controls the power supply to charge the battery module according to the second control signal, and the switch is turned on according to the turn-on signal, allowing the power supply to supply the power to the electronic device via the switch.

16. The electronic device according to claim 15, wherein the battery module includes a first battery and a second battery, and the control unit controls the AC-DC adapter to charge the first battery and the second battery according to the second control signal.
